(19) United States
(12) Patent Application Publication
(10) Pub. No.: US 2008/0029277 A1
(43) Pub. Date: Feb. 7, 2008

(54) METHOD FOR PROTECTING A MOTOR VEHICLE AGAINST FIRE, AND VEHICLE FOR IMPLEMENTING THE METHOD

(76) Inventors: Isabelle LEMAITRE, Grenoble (FR); Olivier Vandroux, Grenoble (FR)

Correspondence Address: Elwood L. Haynes, Suite 1800, 2700 Post Oak Blvd., Houston, TX, 77056, US

(21) Appl. No.: 11/672,585

(22) Filed: Feb. 8, 2007

(30) Foreign Application Priority Data
Feb. 9, 2006 (FR) 06 50458

(51) Int. Cl. A62C 3/07

(52) U.S. Cl. 169/62

(57) ABSTRACT

Method for protecting a moving motor vehicle against fire, the vehicle comprising at least one confined zone (1) comprising at least one inflammable member or element such as an engine compartment or a fuel tank, comprising a step for generating an inert gas consisting of nitrogen-enriched air and a step for diffusing an inert gas generated in the said inflammable confined zone(s) (1), characterized in that the inert gas generating step and the gas diffusing step are carried out permanently at least during the periods of use of the vehicle.

### CROSS REFERENCE TO RELATED APPLICATIONS

This application claims the benefit of priority under 35 U.S.C. § 119 (a) and (b) to French Application No. 06 50458, filed Feb. 9, 2006, the entire contents of which are incorporated herein by reference.

### BACKGROUND

The present invention relates to a method for protecting a motor vehicle against fire, and also to a vehicle for implementing the method.

The invention relates more particularly to a method for protecting a motor vehicle against fire, the vehicle comprising at least one confined zone comprising at least one inflammable member or element such as an engine compartment or a fuel tank for example.

Motor vehicles powered by an internal combustion engine an electric motor or other power source generally comprise confined zones liable to catch fire. These confined or poorly ventilated zones generally contain inflammable members, such as fuel tanks, an engine compartment or similar.

Known fire protection systems for moving vehicles generally use an extinguishing gas (CO₂ for example) combined with a chemical substance forming an extinguishing agent. These protection systems deliver the extinguishing mixture to the sensitive zones in case of detection of an impact or an abnormally high temperature. However, these systems have a complex, bulky and costly structure, and are incapable of satisfactorily extinguishing certain fires. Furthermore, even if these known systems serve to extinguish vehicle fires, they do not prevent the deterioration of certain parts of the vehicle which have begun to catch fire. Moreover, in case of accidental fire, fragile and costly parts may be damaged by the extinguishing products.

Document U.S. Pat. No. 5,590,718 describes such a protection system of the prior art.

It is an object of the invention to propose a method for protecting a motor vehicle against fire which overcomes all or part of the drawbacks of the prior art.

This object is achieved by the fact that the method for protecting a motor vehicle against fire, which also conforms to the above introduction, is essentially characterized in that it comprises:
a step of generating an inert gas and
a step of diffusing an inert gas generated in the said inflammable confined zone(s).

Furthermore, the invention may comprise one or more of the following features:
the inert gas generating step and the gas diffusing step are carried out permanently, at least during the periods of use of the vehicle.

A further object of the invention is to propose a vehicle for implementing the method.

For this purpose, the motor vehicle of the invention, comprising at least one confined zone comprising at least one inflammable member or element such as an engine or a fuel tank, is essentially characterized in that it comprises means for generating an inert gas stream and means for guiding the inert gas stream generated in the said zone(s).

According to other possible features:
the means for generating an inert gas stream comprise a device for separating at least part of the oxygen from a starting gas mixture, such as a polymer-type membrane, the separation device comprising an inlet for a starting gas and an outlet for generating a nitrogen-enriched gas from the starting gas,
the separation device comprises an inlet supplied with air taken from an air circuit flowing within the vehicle and/or directly from outside the vehicle,
the vehicle comprises means for generating a forced flow, such as a compressor, located on the air circuit upstream of an inlet of the separation device,
the vehicle comprises means for controlling the flow rate and non-return means such as a valve located between the outlet of the separation device and the said zone(s),
the vehicle comprises filtration means particularly of the coalescent type on the air circuit upstream of the inlet of the separation device,
the vehicle comprises means for bypassing at least part of the inert gas stream generated towards pressurized gas storage means capable of supplying at least one member of the vehicle such as tires,
the bypassing means comprise a line connected to the inert gas stream generating means and/or the inert gas stream guide means,
the means for guiding the inert gas stream generated in the said zone(s) comprise at least one line.

Other features and advantages of the invention will appear more clearly from a reading of the following description, provided with reference to the figures, in which:

FIG. 1 shows a schematic view illustrating the structure and operation of a protection system according to a first embodiment of the invention,

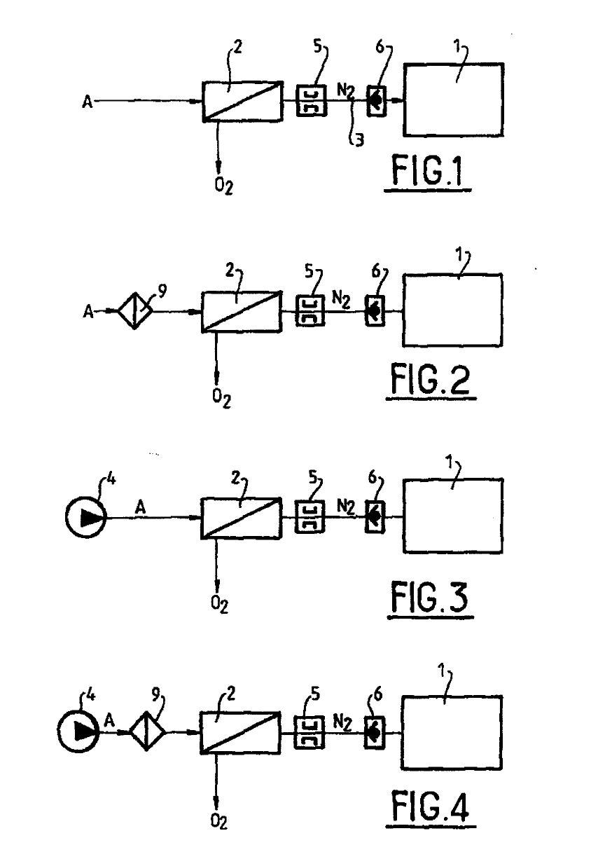

FIGS. 2 to 5 show schematic views illustrating the structure and operation of a protection system according respectively to another four alternative embodiments of the invention.

According to the invention, at least one risk zone of the vehicle is flushed with an inert gas. Preferably, the sensitive zone(s) is/are flushed permanently with inert gas. More precisely, at least during a large part of the periods of use of the vehicle (ignition of the engine or ignition switch, for example), the risk zones such as the engine compartment and/or the fuel tanks are fed with inert gas to ensure that the inert gas creates an inert atmosphere around the inflammable member(s).

The inert gas (for example nitrogen-enriched air) is preferably generated using one or more membranes of the polymer fiber type.

This type of membrane functions according to the following principle: compressed air is injected at the inlet of the membranes and, by diffusion across the walls of the fibers, the air is depleted of oxygen. The nitrogen (N₂)-enriched air thereby generated is then sent to the zones to be protected.

This simple and robust system serves to eliminate the current and more complex extinguishing systems and simultaneously serves to protect the inflammable zones.

For example, the device generally comprises a polymer fiber air separation membrane, sometimes simply called “membrane” or “ASM” (for “Air Separation Module”).

FIG. 1 schematically shows a detail of a vehicle comprising a risk zone 1, for example an engine compartment and a device for protecting the said zone from fire.

The device comprises an air separation membrane 2 comprising an inlet supplied with air A from, for example, an air circuit existing in the vehicle and/or from air taken from outside the vehicle especially for the separation membrane 2.

The membrane 2 comprises a first gas outlet for the gas (N₂) depleted of oxygen and intended for supplying the sensitive zone(s) 1, via means 3 for guiding the inert gas stream such as one or more lines. A calibrated orifice 5 for controlling the inert gas flow rate and a non-return valve 5 to prevent a vapour backflow into the membrane 2 are placed downstream of the first outlet of the membrane 2.

All or part of the components of the device (the membrane 2, the calibrated orifice 5 and the valve 6) may be grouped together and integrated in one or more units, or may be installed separately.

The membrane 2 comprises a second outlet for removing the oxygen (O₂) taken from the gas (air A) feeding the membrane 2.

The zone(s) 1 is/are preferably permanently flushed to prevent or limit the risks of fire and their consequences. The invention provides increased preventive protection compared with known systems. The device of the invention is more compact and cheaper than the systems of the prior art.

In FIGS. 2 to 5, the elements identical to those described above are denoted by the same alphanumeric references and are not shown in detail a second time.

The embodiment in FIG. 2 is distinguished from that of FIG. 1 only in that the means 9 for filtering the air A supplying the membrane 2 are placed upstream of the inlet thereof. For example, the filtration means 9 comprise a filter causing particulate coalescence and filtration. The filtration means 9 are, for example, provided according to the quality of the air fed to the membrane 2.

The embodiment in FIG. 3 is distinguished from that of FIG. 1 only in that the vehicle comprises means 4 for generating a forced flow to create a defined air flow rate A designed to feed the separation device 2. For example, a compressor 4 is placed on the air circuit A upstream of the inlet of the membrane 2. The compressor 4 may be separated from the separation system 2 or may be integrated therein, for example at its inlet. As an alternative, the membrane may share forced flow generation means of another circuit of the vehicle, for example the fan of an engine cooling circuit or of an air-conditioning circuit.

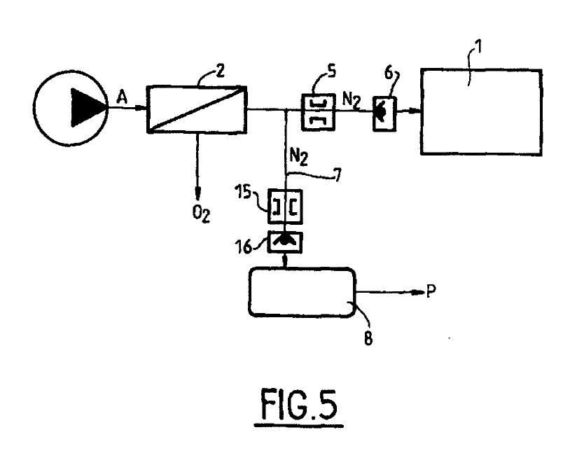

The embodiment in FIG. 4 is distinguished from that of FIG. 3 only in that means 9 for filtering the air A are placed between the compressor 4 (or similar) and the inlet of the membrane 2.

The embodiment in FIG. 5 is distinguished from that of FIG. 3 only in that the vehicle comprises a bypass 7 of at least part of the inert gas stream generated towards pressurized gas storage means 8. For example, a bypass line 7 is connected by its upstream end to the first outlet of the membrane 2 and is connected by its downstream end to a tank 8. The branch line 7 may comprise a calibrated orifice 15 and a non-return valve 16.

The tank 8 is, for example, provided for supplying at least one member (P) of the vehicle such as the tires. For example, the tank 8 has connecting means for connecting a pipe or similar fitted with an adaptor to inflate a tire.

In this way, the system can be provided to inflate tires with a nitrogen-enriched gas. It is then possible to operate the inert gas generator (membrane 2) in a mode designed to lower the oxygen content to a level compatible with the protection of a tire. A selection valve (not shown) can be provided to selectively use the inert gas produced in the sensitive zone 1 and/or in the tank 8. Similarly, means for releasing gas into the tank 8 can be provided to supply zone(s) 1 with gas issuing from the tank 8.

The invention applies to any type of moving vehicle (civil or military) and to any type of sensitive zone to be protected against fire (compartments or windows particularly).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for protecting a moving motor vehicle against fire, the vehicle comprising at least one confined zone comprising at least one inflammable member or element such as an engine compartment or a fuel tank, comprising:
a) a step for generating an inert gas consisting of nitrogen-enriched air; and
b) a step for diffusing an inert gas generated in the said inflammable confined zone(s),
wherein the inert gas generating step and the gas diffusing step are carried out permanently at least during the periods of use of the vehicle.

2. A moving motor vehicle comprising at least one confined zone comprising at least one inflammable member or element such as an engine or a fuel tank, wherein it comprises means for generating an inert gas stream and means for guiding the inert gas stream generated in the said zone(s) designed to generate and guide the inert gas stream permanently in the said zones at least during the periods of use of the vehicle.

3. The vehicle of claim 2, wherein the means for generating an inert gas stream comprise a device for separating at least part of the oxygen from a starting gas mixture, such as a polymer-type membrane, the separation device comprising an inlet for a starting gas and an outlet for generating a nitrogen-enriched gas from the starting gas.

4. The vehicle of claim 3, wherein the separation device comprises an inlet supplied with air taken from an air circuit flowing within the vehicle and/or directly from outside the vehicle.

5. The vehicle of claim 3, wherein it comprises means for generating a forced flow, such as a compressor, located on the air circuit upstream of an inlet of the separation device.

6. The vehicle of claim 3, wherein it comprises means for controlling the flow rate and non-return means such as a valve located between the outlet of the separation device and the said zone(s).

7. The vehicle of claim 3, wherein it comprises filtration means particularly of the coalescent type on the air circuit upstream of the inlet of the separation device.

8. The vehicle of claim 2, wherein it comprises means for bypassing at least part of the inert gas stream generated towards pressurized gas storage means capable of supplying at least one member of the vehicle such as tires.

9. The vehicle of claim 8, wherein the bypassing means comprise a line connected to the inert gas stream generating means and/or the inert gas stream guide means.

10. The vehicle of claim 2, wherein the means for guiding the inert gas stream generated in the said zone(s) comprise at least one line.
